(19) United States
(12) Patent Application Publication
(10) Pub. No.: US 2014/0058893 A1
(43) Pub. Date: Feb. 27, 2014

(54) ORDERING FROM A MENU VIA NFC ENABLED MOBILE DEVICE

(71) Applicants: Carlos A. CAZANAS, Bethlehem, PA (US); Victor M. PAGAN, Breinigsville, PA (US); Jamal N. KHAN, Princeton, NJ (US); Eric BROWN, Edison, NJ (US)

(72) Inventors: Carlos A. CAZANAS, Bethlehem, PA (US); Victor M. PAGAN, Breinigsville, PA (US); Jamal N. KHAN, Princeton, NJ (US); Eric BROWN, Edison, NJ (US)

(73) Assignee: CELLCO PARTNERSHIP D/B/A VERIZON WIRELESS, Basking Ridge, NJ (US)

(21) Appl. No.: 13/592,053

(22) Filed: Aug. 22, 2012

(51) Int. Cl. G06Q 30/06; H04B 5/00

(52) U.S. Cl. 705/26.35; 455/41.1; 705/27.1; 705/26.7

(57) ABSTRACT

An NFC-enabled mobile device is used to select one or more items identified on a menu of a business establishment. The mobile device transmits an order for the selected items to a server of the establishment when the mobile device is brought within range of a near field communication terminal at the premises of the establishment. The mobile device receives a message from the server of the establishment via the wireless transceiver of the device. Based on the information from the message, the mobile device presents to the customer an indication of the status of fulfillment of the order. An initial order of the selection may be sent prior to the order by the mobile device through NFC or other networks, or may be sent via a different device.

### BACKGROUND

In recent years, competition among establishments, on-line shopping options, and measures taken to reduce costs have resulted in the need for a commercial enterprise to find an effective and novel way of providing a memorable and positive experience to a customer.

In general, when a customer enters an establishment, the customer may already know (or quickly determine) what products or services he or she would like to purchase. Typically, a customer wants to minimize the queue time, namely the time between when the customer enters the establishment and the time he or she receives the desired product or service. As to the establishment, they may want to be able to offer differentiated services to each customer. For example, the proprietor of an establishment may not be able to provide products and/or services that fit the customer's specific needs in order to optimize the shopping experience. Indeed, the proprietor may not know when a customer will enter the establishment, what the customer preferences are (e.g., based on prior purchases), what the customer is interested in now, and whether the product or service is currently available. Accordingly, if the proprietor does not know when someone enters an establishment or has additional information about who has just entered, time may be wasted in determining the customer's needs at the point of service (i.e., when the customer is assisted by the proprietor). This delay may result in a significantly diminished customer experience.

Some establishments increase the number of personnel to assist the customer more quickly. However, this is inefficient in that it involves additional cost and still requires the determination a customer's requirements after the customer has entered the establishment.

Hence, there is still room for further improvement to enhance the interaction with a customer, for example, to ensure continued and efficient patronage of the commercial establishment.

### BRIEF DESCRIPTION OF THE DRAWINGS

The drawing figures depict one or more implementations in accord with the present teachings, by way of example only, not by way of limitation. In the following figures, like reference numerals refer to the same or similar elements.

FIG. 1 illustrates a system offering an exemplary framework to provide automatic processing of a selection in the form of an order.

FIG. 2 illustrates details of an exemplary NFC terminal that is in wireless communication with a mobile device.

FIG. 3a illustrates an exemplary mobile device communicating with an NFC terminal to transmit an order and/or order confirmation to the NFC terminal.

FIG. 3b illustrates an exemplary flow wherein an NFC enabled mobile device provides an initial order without NFC communication and then completes the order via NFC communication with an NFC terminal.

FIG. 3c illustrates an exemplary order flow from the perspective of a server.

FIG. 4 illustrates a high level simplified functional block diagram of an exemplary mobile device.

FIG. 5 illustrates a network or host computer.

FIG. 6 depicts a computer with user interface elements.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The various examples disclosed herein relate to efficient electronic processing of customer orders by using a fixed location Near Field Communication (NFC) terminal that receives order/confirmation information wirelessly from a mobile device that is NFC compatible. The order (or confirmation) is received by an NFC terminal when the mobile device in close proximity to the NFC terminal (e.g., 4 to 10 cm—the effective proximity is provided by the NFC forum standards). For example, the mobile device has stored therein order information that is communicated to the NFC terminal to automatically process the order.

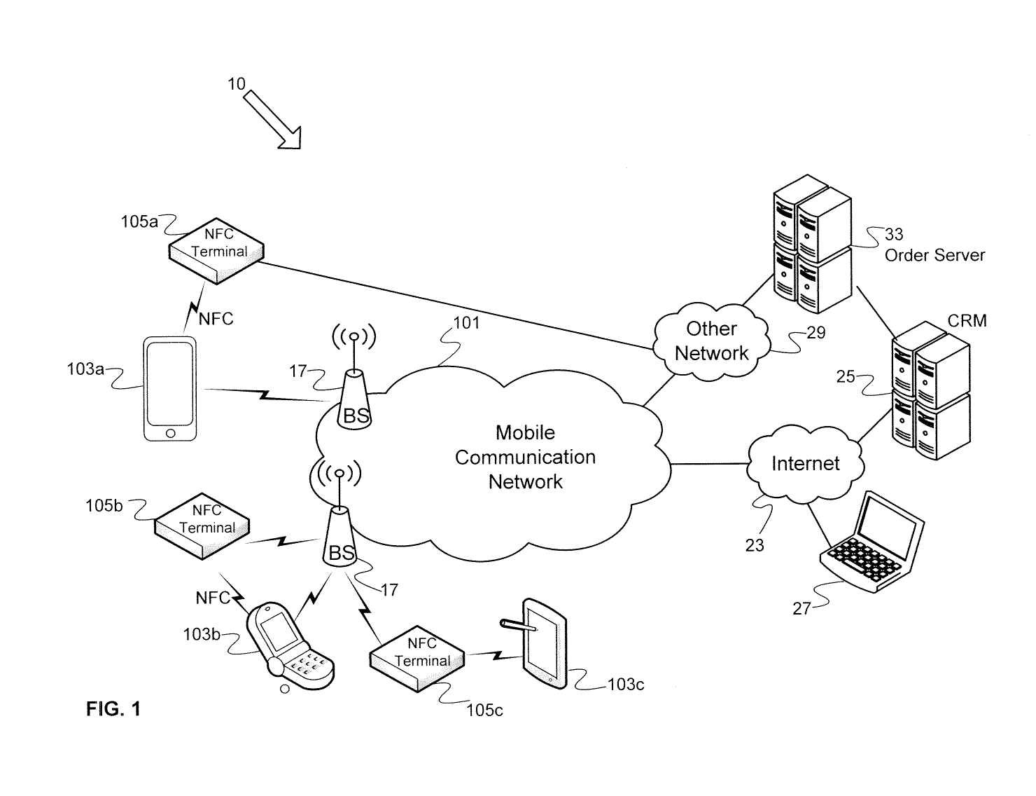

Reference now is made in detail to the examples illustrated in the accompanying drawings and discussed below. FIG. 1 illustrates a system 10 offering a framework to provide automatic processing of order selection. The example shows several mobile devices 103a to 103c (collectively referred to as mobile devices) that are examples of devices that may be used for communicating with (e.g., fixed location) NFC terminals 105a to 105c (i.e., through NFC communication) when a mobile device is in close proximity to a respective NFC terminal. Mobile devices 103a to 103c, for example, can take the form of portable handsets including feature phones, smart phones and advanced phones, as well as tablet computers and mobile computers. For purposes of the automatic processing of order selection can access the network 101 for mobile communication purposes and have NFC communication capability.

NFC is a set of standards for smart phones and similar devices, such as the mobile devices (e.g. 103a to 103c) discussed herein, to establish radio communication with other such devices as well as with compatible NFC terminals by coming to close proximity. Due to its short range and support for encryption, NFC communication is suitable for secure communication over short distances. Accordingly, NFC technology is included in mobile devices 103a to 103c as well as NFC terminals 105a to 105c.

NFC terminals 105a to 105c each include a transceiver configured to communicate with NFC capable mobile devices 103a to 103c. For example, a transceiver comprises an NFC chipset. Each NFC terminal 105a to 105c provides two-way wireless communication of information in accordance with NEC technology and protocols. For example, a mobile device 103a can communicate its order information to a local NFC terminal 105a at a commercial establishment. An establishment may have one or more of these NFC terminals to receive order information from the mobile device 103a. NFC terminals 105a to 105c may be conveniently located throughout one or more premises of an establishment (e.g., at an entrance, outside the premises, at the pick up area/register, at a drive through location, or the like).

In one example, the NFC terminal 105a is connected to a private IP type packet data network 29 (sometimes referred to as an Intranet) of the establishment, which is discussed later.

The mobile communication network 101 provides communications for mobile devices 103a and 103b as well as for mobile devices/users that do not participate in NFC-based services (e.g., regular mobile devices such as cell phones, tablet computers, etc. that do not include NFC chip sets or devices that have such chip sets but whose users do not participate in any NFC-based service). Thus, network 101 may provide regular voice and data cellular services. The network 101 provides wireless communications services to the mobile devices shown and other mobile devices (not shown), via a number of base stations (BSs) 17. The present techniques may be implemented in any of a variety of available mobile networks 101 and/or on any type of mobile device compatible with such a network 101, and the drawing shows only a very simplified example of a few relevant elements of the network 101 for purposes of discussion here.

The mobile communication network 101 may be implemented as a network conforming to the code division multiple access (CDMA) IS-95 standard, the 3rd Generation Partnership Project 2 (3GPP2) wireless IP network standard or the Evolution Data Optimized (EVDO) standard, the Global System for Mobile (GSM) communication standard, a time division multiple access (TDMA) standard, the Long Term Evolution (LTE) standard, or other standards used for public mobile wireless communications. In one example, the mobile devices 103a and 103b are capable of voice telephone communications through the network 101, for communicating order information to the order server 33, and receiving order status information from the order server 33. The mobile devices 103a to 103c are capable of data communications through the particular type of network 101, and the users thereof typically will have subscribed to data service through the network.

The network 101 allows users of the mobile devices such as 103a to 103c (and other mobile devices not shown) to submit order information to an order server 33 that is configured to receive order information from mobile devices 103a to 103c. The network 101 typically offers a variety of data services via the Internet 23, such as downloads, web browsing, email, messaging, etc. By way of example, the drawing shows a laptop PC type user terminal 27 as well as a customer relations management (CRM) server 25 connected to the Internet 23; and the data services for the mobile devices 103a to 103c via the Internet 23 may be with devices like those shown at 25 and 27 as well as with a variety of other types of devices or systems capable of data communications through various interconnected networks.

The mobile communication network 101 can be implemented by a number of interconnected networks. Hence, the overall network 101 may include a number of radio access networks (RANs), as well as regional ground networks interconnecting a number of RANs and a wide area network (WAN) interconnecting the regional ground networks to core network elements. A regional portion of the network 10, such as that serving mobile devices 103a to 103c, can include one or more RANs and a regional circuit and/or packet switched network and associated signaling network facilities.

Physical elements of a RAN operated by one of the mobile service providers or carriers include a number of base stations represented in the example by the base stations (BSs) 17. Although not separately shown, such a base station 17 can include a base transceiver system (BTS), which can communicate via an antennae system at the site of base station 17 and over the airlink with one or more of the mobile devices 103, when the mobile devices 103a to 103c are within range. Each base station 17 can include a BTS coupled to several antennae mounted on a radio tower within a coverage area often referred to as a “cell.” The BTS is the part of the radio network that sends and receives RF signals to/from the mobile devices 103a to 103c that are served by the base station 17. The network can also include other elements that support functionality other than device-to-device media transfer services such as messaging service messages and voice communications. Specific elements of the mobile communication network 101 for carrying the voice and data traffic, and for controlling various aspects of the calls or sessions through the network 101, are omitted here for simplicity. It will be understood that the various network elements can communicate with each other, as well as other aspects of the mobile communication network 101, and other networks (e.g., the public switched telephone network (PSTN) and the Internet 23) either directly or indirectly.

The carrier may also operate a number of systems that provide ancillary functions in support of the communications services and/or application services provided through the mobile communication network 101, and those elements communicate with other nodes or elements of the mobile communication network 101, such as one or more private IP type packet data networks 29 (sometimes referred to as an Intranet), i.e., a private network. Generally, such systems are part of or connected for communication via the private network 29 of the establishment discussed herein. It will be understood that systems outside of the private network could serve the same functions as well. Examples of such systems, in this case operated by the network service provider as part of the overall system 10, which communicate through the intranet type network 29, include one or more order servers 33.

An order server 33 may be located on premises (e.g., at point of service of the establishment) or off premises. The order server 33 is configured to process order information. Order information may include the products and/or services of one or more entities requested by the customer, a confirmation to process the order by the customer when at the premises, and/or payment information. In one example, order information is received from a mobile device 103a by the NFC terminal 105a via NFC, which is provided to the order server 33. In another example, an initial order information is received from a PC 27 over the internet 23 (e.g., via a customer management server 35 or by the order server 33 directly), through a mobile communication network 101, the internet 23, or through a plain old telephone service (POTS), not shown. An “initial order information” as used herein is different from “order information” in that the latter is placed through NFC communication. Accordingly, order information that is not received through an NFC terminal is considered an initial order. For example, an initial order is later confirmed (i.e., confirmation order) by the mobile device 103a when the mobile device 103a interacts with an NFC terminal (e.g., 105a).

The order information may inform (and/or provide confirmation to) enterprise personnel what products and/or services the customer has ordered. Further, order information through an NFC terminal (e.g., 105a) indicates customer arrival at the premises and allows enterprise personnel to adapt their interaction to the particular customer. Accordingly, the signaling from the mobile device 105a to the NFC terminal 105a serves as an identifier of the mobile device and/or the customer to a system of the proprietor of the enterprise. The identification can serve logically as a ‘customer check-in,’ for example, to allow the order server 33 and a representative of the proprietor to automatically obtain (via NFC) both an indication that the customer has entered the establishment as well as customer specific information from a customer information database (e.g., within the order server 33 or an associated CRM server 25).

As noted above, the order server 33 may also include or have access to a CRM server 25 that includes a customer information database. For example, CRM server 25 may include basic key facts about the customer, such as gender, age, geographic location, prior purchase information and/or customer preferences that have been gathered from prior purchases or provided by the customer. For example, customer purchases (associated through one or more mobile devices) gathered from prior purchases at the establishment or at similar establishments may be stored in the CRM server 25. In one example, the CRM server 25 offers its account holders on-line access to a variety of functions related to the account holders' accounts, such as prior purchases, the last product/service ordered, on-line payment information, subscription changes, specials tailored for the account holder, password control, etc. The information may be used to provide a detailed understanding of the experience the customer has in interacting with the establishment, and allows predictions to be made regarding reasons behind customer behaviors, such as the type of product/service purchased, the amount of money spent, etc.

In one example, CRM server 25 provides an account holder interface via the Internet 23. For example, a user's terminal, such as PC 27, may be used to access on-line information about an account holder's (i.e., customer's) account, which the establishment makes available via their web site accessible through the Internet 23. In one example, CRM 25 is configured to receive on-line orders through the PC 27, although the CRM 25 may also receive on-line orders from mobile devices 103a to 103c when not using NFC capabilities. The order is communicated by the CRM 25 to the order server 33. In one example, when the CRM 25 forwards an order to the server 33, the mobile device (e.g., 103a) associated with the account is sent a message by the order server 33. The message includes information that is configured to be used by an application of the mobile device 103a to communicate with an NFC terminal (e.g., 105a) when arriving at the premises of the establishment. As discussed above, the communication between the mobile device 103a and the NFC terminal 105a provides “a customer check-in” to the establishment. Accordingly, the order is able to be processed while the customer is away from the premises and perhaps initiated in response to the NFC customer check-in, thereby allowing the establishment to provide an enhanced customer experience, e.g., by reducing wait time.

The information presented at the web site of the establishment may include products/services that can be purchased. For example, the web site may provide a food menu that a customer can select from using a PC terminal 27 or the mobile device 103. In various embodiments, specials (e.g., configured for the account holder) may be displayed, the account holder may be offered to select the same meal, the most frequently selected meal, or a selection of previously frequently selected meals from the establishment as last time with a single “click,” promotional items may be displayed, and the like. In one example, upon the CRM server 25 (or order server 33) receiving the initial order information, a message is sent by the CRM server (or order server 33) to the mobile device 103a associated with the account. This message includes information that is configured to be used to communicate with an NFC terminal (e.g., 105a), as discussed above.

In one example, applications, including an application to make product/service selections and receive order updates, can be configured to execute on many different types of mobile devices 103a to 103c. For example, a mobile device application can be written to execute on a binary runtime environment for mobile (BREW-based) mobile station, a Windows Mobile based mobile station, Android, Apple iOS devices (I-Phone or iPad), Java Mobile, or RIM based mobile station such as a BlackBerry or the like. Some of these types of devices can employ a multi-tasking operating system.

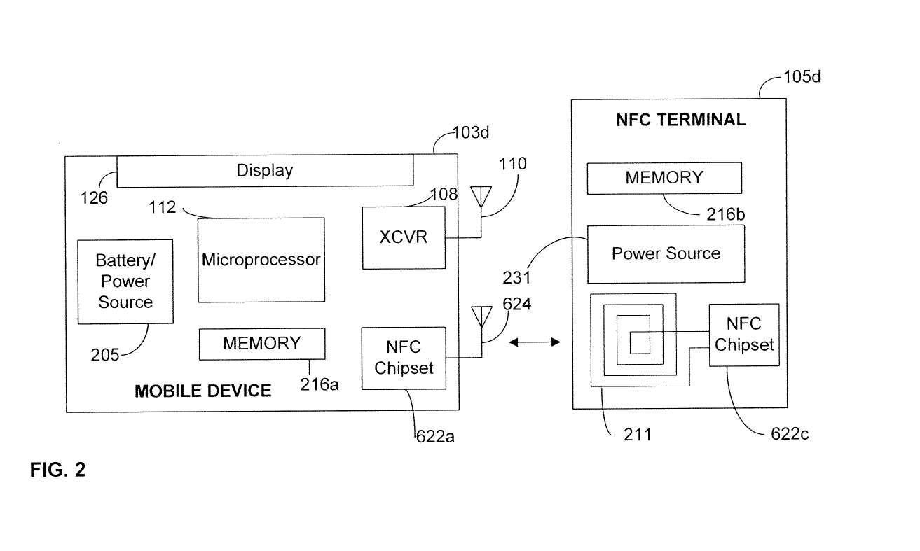

FIG. 2 illustrates details of an exemplary NFC terminal that is in wireless communication with a mobile device 105d. The simplified block diagram of the mobile device 103d includes a display 126, a battery/power source 205, a microprocessor 112, a memory 216a, and an NFC chipset 622a capable of communicating with a NFC terminal (e.g., 105d) that is NFC compatible via antenna 624. In one example, NFC terminal 103d includes a transceiver 108 that is capable of communication with order server 33 through a mobile communication network 101 and the Internet 23 via antenna 110. The components of a mobile device are discussed in more detail later.

In the example of FIG. 2, mobile device 103d communicates with NFC terminal 105d to transmit an order and/or order confirmation to the NFC terminal 105d by NFC communication. NFC generally involves an initiator and a target. For example, a mobile device 103d (e.g., an initiator in this example) may generate an RF field via its inductive antenna 624 that is received by antenna 211 of the NFC terminal 105d. In this example, both the NFC terminal 105d and the mobile device 103d include a battery/power source, 205 and 231 respectively. In this regard, NFC peer-to-peer communication is possible between the mobile device 103d and the NFC terminal 105d and either device (e.g., NFC terminal 105d or the mobile device 103d) can be an initiator.

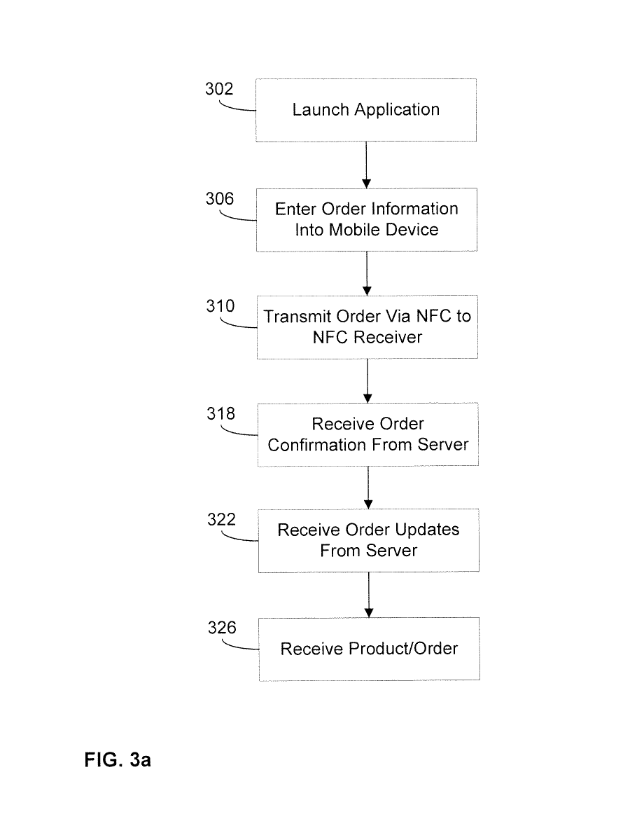

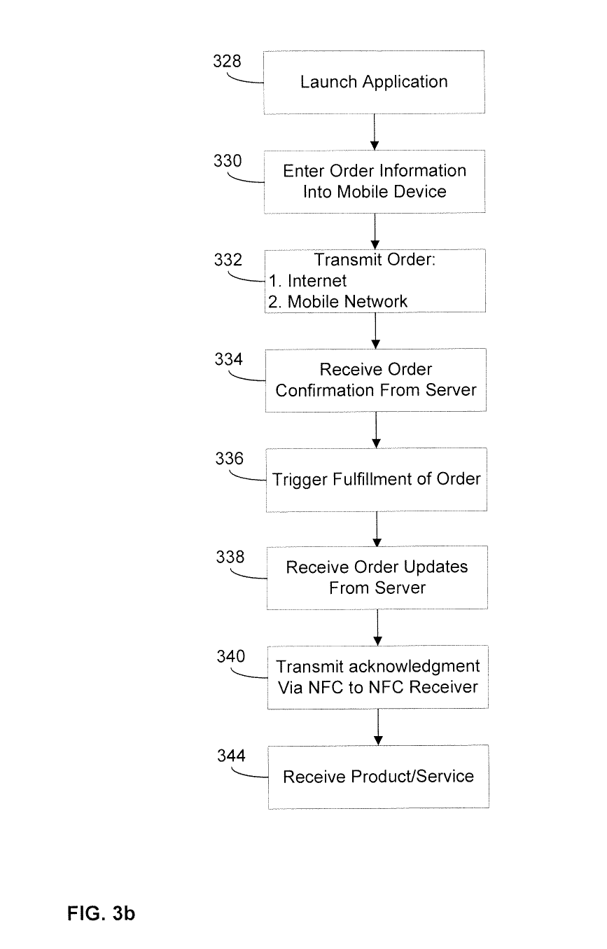

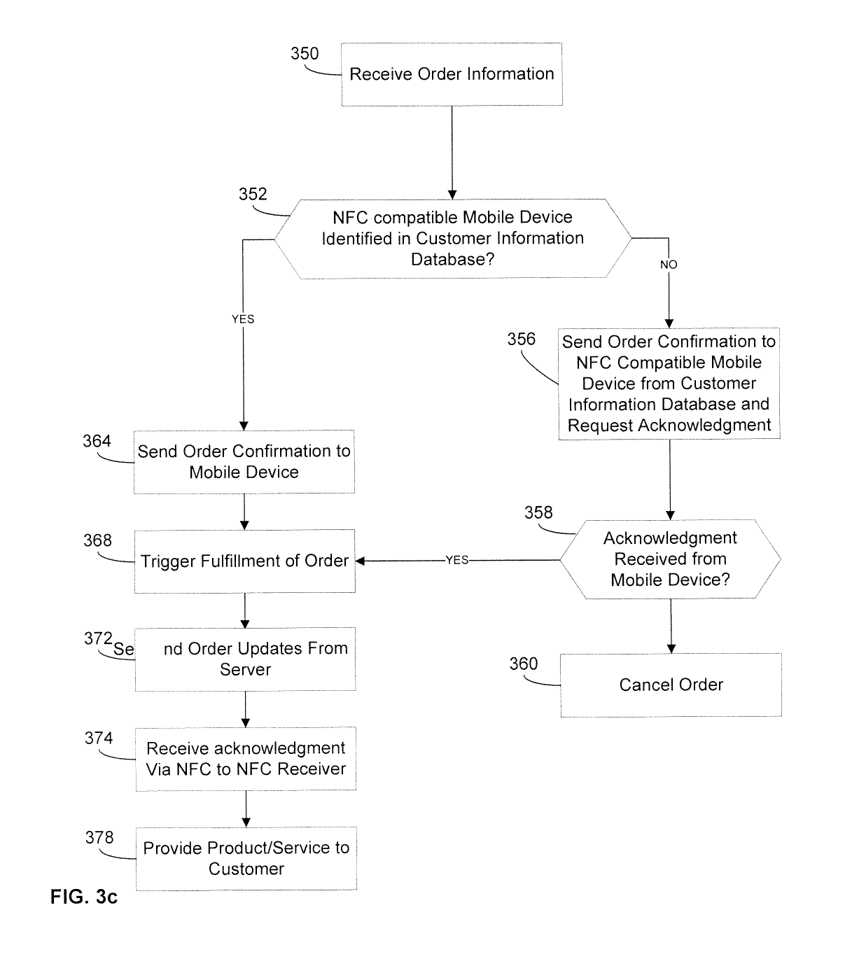

With the foregoing overview of the system, it may be helpful now to consider high-level examples of ordering a product/service with the use of an NFC enabled mobile device 103a. FIG. 3a illustrates an exemplary flow wherein an NFC enabled mobile device 103a communicates with an NFC terminal to communicate an order. In step 302 an application that allows an order to be made by the user, based on a menu selection for an establishment, is launched on a mobile device 103a. For example, the application may display on a user interface (e.g., touch-screen) of the mobile device 103a a menu selection, what has been ordered last from the establishment, specials that the customer may be interested in, and the like. The menu items may be products and/or services offered by the establishment. One example of an establishment is a fast food enterprise, such as McDonalds, in which the menu items are food and beverages. Other establishments may provide menus having services, such as dry cleaners, or non-food items or services. For example, a customer of Best Buy may make selections of products that he or she wants to purchase directly on their mobile device 103a. The order information is communicated to the order server 33 via an NFC terminal 105a. The customer can then pick up the order from the counter without having to wait in line.

In one example, the program uses the global positioning system (GPS) coordinates, provided by the GPS receiver of the mobile device 103a, to determine the closest premises of the establishment where the order can be picked up when the establishment has multiple outlets. In one example, the menu items are specific to the products/services for the particular premises selected. The application may communicate with a CRM 25 (e.g., via the mobile communication network 101 or the internet 23 through Wifi through its wireless transceiver configured for mobile data communication via the mobile wireless communication network 101) to obtain latest promotional information (e.g., latest deals and/or suggestions based on information harvested in the CRM 25). The promotional information is provided on the user interface (e.g., touch-screen) of the mobile device 103a.

In step 306, the order information is entered into the mobile device 103a by making menu selections and/or entering information into the application. In one example, the application provides an option to repeat the last order with the touch of a single button on the user interface of the mobile device 103a.

In step 310, the order is transmitted from the mobile device 103a to the order server 33 by communicating with an NFC terminal 105a via NFC. For example, the mobile device 103a is brought in close proximity to one of possibly several NFC terminals 105a, which may be located throughout the premises of an establishment.

In various examples, payment for the order can occur at different steps. In one example, the payment for the order occurs at step 310 (e.g., when the order is initially placed). In another example, the payment occurs in response to a subsequent confirmation (step not shown) or when the order is received by the customer (e.g., step 326). As to the payment for the order, a customer may store credit card, loyalty card, gift card, coupon, etc. information on the mobile device 103a, which is then used by the application. The payment information is communicated to the order server 33 through the NFC terminal 105a (which may or may not be the same NFC terminal through which the order was placed or the “customer check-in” has occurred).

The mobile device 103a may receive an order confirmation from the order server 33 (i.e., step 318). The order confirmation may be provided by the order server 33 while the mobile device 103a is still in close proximity with the NFC terminal 105a (via NFC). In another example, the confirmation is provided to the mobile device 103a by the order server 33 via the mobile communication network 101.

It will be understood that an order may not be available immediately. In this regard, order messages indicating the status of the order may be received by the mobile device 103a from the order server 33 (i.e., step 322). For example, the establishment may be in communication with the order server 33, thereby informing the order server the status of the order. In turn, the order server provides status information to the mobile device 103a. The status information (e.g. provided in one or more messages) may include SMS updates provided directly to the application, XML over the internet 23, and/or XML over the mobile communication network 101. In one example, order messages indicating the status of the order are periodically received until the one or more items are received by the customer. For example, the mobile device 103a may be notified what the anticipated wait time (e.g., time to the order being filled) is. When the order is ready for the customer, the mobile device 103a may be notified with a message, as discussed above, that may indicate from where (e.g., which counter) to pick up the order.

In step 326, the payment is made (if it has not already been made, as discussed above) and the order is received by the customer. For example, the order information may be displayed on the mobile device as a confirmation to the vendor that this is the correct recipient (i.e., customer). In one example, if the order has not yet been paid for, the mobile device 103a is brought in close proximity to an NFC terminal (e.g., at the respective pickup counter) to (i) indicate that this is the correct recipient (i.e., customer) and/or (ii) provide payment information. In one example, the purchase information is stored under the customer information database in the CRM 25. Accordingly, there is an enhanced interaction with a customer to ensure efficient and continued patronage of the commercial establishment.

FIG. 3b illustrates an exemplary flow wherein an NFC enabled mobile device 103a provides an initial order without NFC communication. The mobile device 103a subsequently completes the order via NFC communication with an NFC terminal by providing confirmation information.

In step 328, an application that allows an order to be made, based on a menu selection for an establishment, is launched on a mobile device 103a.

The order information is entered into the mobile device 103a by making selections and/or entering information into the application (i.e., step 330). In one example, the program uses the GPS coordinates provided by the GPS receiver of the mobile device 103a to determine the closest premises of the establishment where the order can be picked up. The application may communicate with a CRM 25 (e.g., via the mobile communication network 101 or the internet 23 through Wifi) to obtain latest promotional information (e.g., latest deals and/or suggestions based on information harvested in the CRM 25). The promotional information is provided on the user interface (e.g., touch-screen) of the mobile device 103a.

In step 332, the initial order information is transmitted to the order server 33 (or CRM 25) through (i) the internet (e.g., 23) through Wifi, or (ii) the mobile communication network 101. Thus, the initial order information can be provided to the order server 33 while the customer is still far away from the premises of the business establishment.

In step 334, an order confirmation is received by the mobile device 103a from the order server 33. The order confirmation may be received as a message (e.g., SMS directly to the application of the mobile device), XML over the mobile communication network 101, or over the internet 23, if available. For example, the confirmation message may be provided on the user interface (e.g., touch-screen) of the mobile device 103a.

Similar to the above examples, payment for the order can occur at different steps. In one example, the payment for the order occurs at step 332 (e.g., when the initial order information is transmitted). In another example, the payment occurs when the fulfillment of the order is triggered (discussed in step 336 below). In another example, the payment occurs when an acknowledgment is transmitted from the mobile device 103a to the order server 33 in step 340. In yet another example, payment occurs when the product/service is received at the point of service (e.g., step 344). Each of the steps 336 to 344 is discussed in more detail below.

In step 336, the fulfillment of the order is triggered. Put differently, the establishment is instructed to execute the order, such that it will likely be ready by the time the customer is expected to arrive at the premises of the establishment. In various examples, the fulfillment of the order may be triggered by different events. In one example, the application on the mobile device 103a provides distance and/or GPS information to the order server 33 via a message over the mobile communication network. The distance may be calculated by the order server 33 based on the UPS information provided by the mobile device 103a or can be calculated by the mobile device 103a and sent to the order server 33. When the mobile device 103a is a predetermined distance (e.g., 1 mile) from the premises of the establishment, the order is executed, such that it will be ready by the time the customer is estimated to arrive. The predetermined distance may vary for different areas and/or time of the day (e.g., based on traffic congestion). For example, for the same distance between a customer and an establishment, the order server 33 may allocate more time (e.g., 100% time increase) during rush and/or for urban areas versus off peak hours and/or rural areas. In another example, the order server 33 may refer to a traffic server (not shown) that provides traffic congestion information, to better estimate the time the customer placing the order will arrive.

In another example, the fulfillment of the order is triggered based on a predetermined time from when the initial order information is transmitted from the mobile device 103a to the order server 33. The predetermined time may vary based on the GPS information received from the mobile device 103a. Thus, the further away the customer is, the longer the expected time of arrival increases, thereby setting a longer predetermined time.

In one example, order status messages are received by the mobile device 103a from the order server 33 (i.e., step 338). For example, the mobile device 103a may be notified what the anticipated wait time is. The status update messages may be periodic or in response to specific events. For example, when the order is ready, the mobile device may be notified as to where (e.g., which counter or drive through lane) to pick up the ordered product/service.

In one example, when the customer is at the premises of the establishment, an order acknowledgment is transmitted by the mobile device 103a via NFC to the NFC terminal 105a (i.e., step 340). In this regard, the mobile device 103a is brought in close proximity to one of possibly several NFC terminals 105a at the premises of an establishment. This identification can serve logically as a “customer check-in,” for example, to allow the order server 33 and a representative of the proprietor to automatically obtain both an indication of that the customer has entered the establishment as well as customer specific information from a customer information database (e.g., within the order server 33 or an associated CRM server 25).

In step 344, the ordered product/service is received. For example, the order information may be displayed on the mobile device as a confirmation to the vendor that this is the correct recipient (i.e., customer). In one example, if the order has not yet been paid for, the mobile device 103a is brought in close proximity to an NFC terminal (e.g., at the respective pickup counter) to (i) indicate that this is the correct recipient and/or (ii) provide payment information. In one example, the purchase information is stored in the customer information database in CRM server 25. Accordingly, the customer has the opportunity to place an initial order over the mobile device 103a and have the product/service ready for pick-up by the time he or she arrive at the premises of the establishment, thereby providing an enhanced customer experience with the establishment.

FIG. 3c illustrates an exemplary product/service order flow from the perspective of an order server 33 (or CRM server 25). In step 350, order information is received by the order server 33 by one of several ways. In one example, order information may be received from a user's terminal, such as PC 27, that interacts with a web-site of an establishment over the internet 23. The information presented at the web site of the establishment may include product/service that can be purchased. In another example, order information is received from a mobile device 103a that has an application stored in its memory that allows placement of an order through a user interface. The order information includes one or more product/service that is being purchased. In one example, the order information includes the GPS coordinates of the mobile device 103a that is placing the order.

In step 352, it is determined (e.g., by the order server 33 based on the configuration information provided by the customer at registration time) whether the order originated from an NFC compatible mobile device 103a identified in the customer information database of the order server 33 (or CRM 25). Upon determining that the order originated from an NFC compatible mobile device 103a, an order confirmation message is sent by the CRM server 25 (or order server 33) to the mobile device 103a associated with the account (i.e., step 364). This message includes information that is configured to be later used to communicate with an NFC terminal (e.g., 105a) when the customer arrives at the premises of the establishment.

In step 368, the fulfillment of the order is triggered, wherein the order server 33 is instructed to fulfill the order, such that it will likely be ready by the time the customer is estimated to arrive at the premises of the establishment. In various examples, the trigger for the fulfillment of the order occurs in different ways. In one example, the order server 33 receives a distance and/or GPS information from the mobile device 103a via a message over the mobile communication network 101. The distance may be provided by the mobile device 103a or calculated by the order server 33, based on the GPS information provided by the mobile device 103a. When the mobile device 103a is a predetermined distance (e.g., 1 mile) from the premises of the establishment, a signal is received from the mobile device 103a that triggers the fulfillment of the order, such that the product/service will likely be ready by the time the customer is estimated to arrive.

In one example, order status messages are sent to the mobile device 103a by the order server 33 (i.e., step 372). For example, the mobile device 103a may be notified what the anticipated wait time is. Status messages may be periodic and/or in response to events. For example, when the order is ready, the mobile device may be notified where (e.g., which counter or drive through lane) to pick up the order from.

In one example, when the customer is at the premises of the establishment, an order acknowledgment is received from the mobile device 103a through NFC via the NFC terminal 105a (i.e., step 374). In this regard, the mobile device 103a is brought to close proximity with one of possibly several NFC terminals 105a at the premises of an establishment. This identification serves as a ‘customer check-in,’ for example, to allow the order server 33 (and a representative of the proprietor) to automatically obtain both an indication that the customer has entered the establishment as well as customer specific information from a customer information database (e.g., within the order server 33 or an associated CRM server 25).

In step 378, the product/service is provided to the customer. In one example, if the order has not yet been paid for, payment information is received by the order server 33 when the mobile device 103a is brought in close proximity to an NFC terminal (e.g., at the respective pickup counter) to (i) indicate that this is the correct recipient and/or (ii) provide payment information.

As further regards payment information, in various examples, payment for the order can occur at different steps. In one example the payment for the order occurs when the (initial) order information is received (i.e., step 350). In another example, the payment occurs when the fulfillment of the order is triggered (i.e., step 368). In one example, the payment occurs when an acknowledgment is received by the order server 33 from the mobile device 103a (i.e., 374). In yet another example, payment occurs when the ordered product/service is provided to the customer (i.e., step 378).

Referring back to step 352, upon determining that the order did not originate from an NFC compatible mobile device 103a, an order confirmation message is sent by the CRM server 25 (or order server 33) to the mobile device 103a associated with the account (i.e., step 356). For example, the mobile device 103a associated with the account is NFC compatible.

In step 358, it is determined whether an acknowledgment is received from the NFC compatible mobile device 103a. If an acknowledgment is not received (e.g., within a predetermined time) from the mobile device 103a, the order is canceled (i.e., step 360). However, upon determining that there is an acknowledgment from the mobile device 103a, the method continues with step 368, as discussed above. Thus, even though the order may not have originated from an NFC compatible mobile device (e.g., it may have originated from a PC) the ordering process can continue with an NFC enabled mobile device 103a.

While the flow in FIG. 3c commences with the step of receiving an order information (i.e., step 350), other examples, where additional steps are performed by the order server 33 prior to receiving the order information, are contemplated as well. For example, when the customer launches the application on the mobile device 103a or logs on to their account managed by the CRM 25 server via a PC 27, the CRM 25 may provide specials tailored for the customer based on the information stored in the customer information database. Thus, the CRM server 25 (e.g., via the mobile communication network 101 or the internet 23 through Wifi) may provide latest promotional information (e.g., latest deals and/or suggestions based on the customer information and the GPS location of the customer obtained from the mobile device 103a). The promotional information is provided on a user interface (e.g., touch-screen) of the mobile device 103a or screen of the PC 27.

In one example, the purchase information is stored under the customer information database in the CRM 25. Other examples include tie-ins to loyalty programs of the establishment or associated entities. Promotions, such as rebates and/or giveaways, may also be triggered by the use of the application on the mobile device 103a or when visiting the web site of the establishment.

The order information received from a customer may aid in inventory management. In some examples, available items listed on the establishment web-site or through the application may be adjusted in response to the aggregate orders from this and other customers. In one example, daily specials may be adjusted to remove items that are sold out and/or to provide alternate specials.

To maintain the security of the system 10 described herein, a hash unique to the application identification (ID) may be used. A hash is an algorithm or subroutine that maps large data sets of variable length, called keys, to smaller data sets of a fixed length. For example, an NFC ID of the mobile device and a business establishment account information could be hashed to a single integer. The values returned by a hash function are called hash values, hash codes, hash sums, checksums or simply hashes. The hash may be used to generate private and public keys, the public key of which is sent to the order server 33 when the application is downloaded or activated by the mobile device 103a (either initially or each time). For example, personal information, such as credit card information, would be securely provided on the mobile device 103a if desired for transmission with the order, for example, by encrypting the credit card information using the application ID hash. Otherwise, the credit card information may be stored on a secure server in the cloud. In other examples, rather than using personal information and hash/keys, purchases could be anonymous. In this regard, IDs could be assigned randomly.

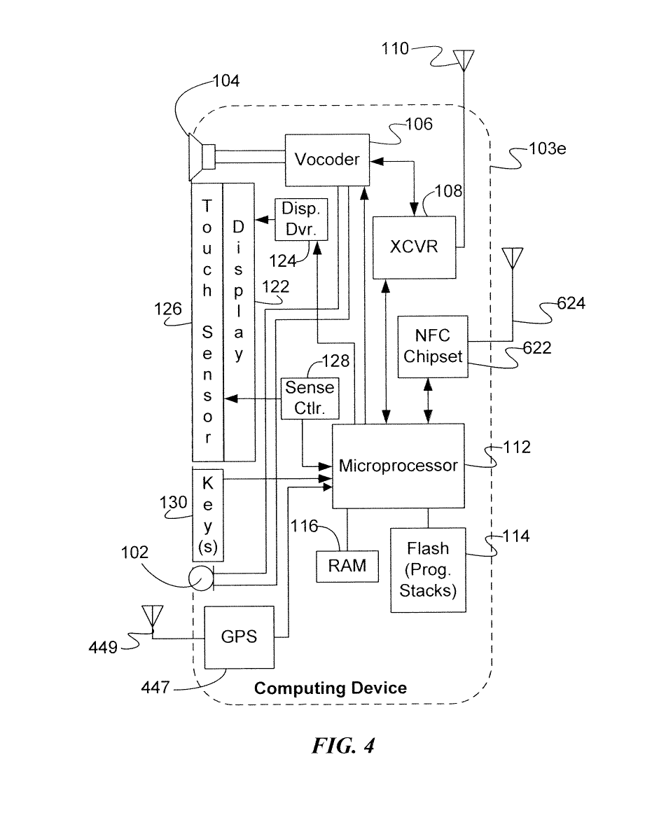

As shown by the discussion of the method of FIG. 1, the ordering of product/service from a menu involves an interaction with an appropriately configured mobile device (e.g., 103a). A mobile device may be mobile or stationary. In this regard, it may be useful to consider the functional elements/aspects of an exemplary mobile device, at a high-level. For purposes of such a discussion. FIG. 4 provides a block diagram illustration of an exemplary mobile device 103e. Although the mobile device 103e may be a handset type mobile phone or may be incorporated into another device, such as a personal digital assistant (PDA), a tablet computer, or the like. For discussion purposes, the illustration shows the mobile device 103e in the form of a handheld smart-phone. The smart-phone example of the mobile device 103e may function as a normal digital wireless telephone station. For that function, the mobile device 103e includes a microphone 102 for audio signal input and a speaker 104 for audio signal output. The microphone 102 and speaker 104 connect to voice coding and decoding circuitry (vocoder) 106. For a voice telephone call, for example, the vocoder 106 provides two-way conversion between analog audio signals representing speech or other audio and digital samples at a compressed bit rate compatible with the digital protocol of wireless telephone network communications through mobile communication network 101 and possibly voice over packet (Internet Protocol) communications if supported by the mobile device 103e and the data services through the mobile communication network 101.

For digital wireless communications, the mobile device 103e also includes at least one digital transceiver (XCVR) 108. The transceiver (XCVR) 108 could be a multimode transceiver, or the mobile device 103d may include two or more transceivers each of which supports a subset of the various technologies or modes. The concepts discussed here encompass examples of the mobile device 103d utilizing any digital transceivers that conform to current or future developed digital wireless communication standards.

The transceiver 108 provides two-way wireless communication of information, such as vocoded speech samples and/or digital message information, in accordance with the technology of the network 101. In this case, the transceiver 108 also sends and receives a variety of signaling messages in support of the various voice and data services provided via the mobile device 103e and the communication network. Each transceiver 108 connects through RF send and receive amplifiers (not separately shown) to an antenna 110. In the example, the transceiver 108 is configured for RF communication in accord with a digital wireless protocol, such as the current CDMA and 3GPP protocols.

The mobile device 103e includes a display 122 for displaying messages, menus or the like, call related information dialed by the user, calling party numbers, etc. The mobile device 103e also includes a touch/position sensor 126. The sensor 126 is relatively transparent, so that the user may view the information presented on the user interface (i.e., display) 122, A sense controller 128 sensing signals from elements of the touch/position sensor 126 and detects occurrence and position of each touch of the screen formed by the display 122 and sensor 126. The sense circuit 128 provides touch position information to the microprocessor 112, which correlates that information to the information currently displayed via the display 122, to determine the nature of user input via the screen.

The display 122 and touch sensor 126 (and possibly one or more keys 130, if included) are the physical elements providing the textual and graphical user interface for the mobile device 103e. The microphone 102 and speaker 104 may be used as additional user interface elements, for audio input and output. Of course, other user interface elements may be used, such as a trackball, as in some types of smart phones or tablets.

In one example, the mobile device 103e also includes a GPS receiver 447 for communicating with satellites via antenna 449. The GPS receiver 447 locates a plurality of satellites, determines the distance to each, and uses this information to deduce its own location. For example, the simple mathematical principle of trilateration is used to determine the location information of the mobile device 103e.

The mobile device 103e may also include a haptic element (not shown) to provide haptic feedback to the user. Various combinations of the keypad 120, display 122, microphone 102, haptic element, and speaker 104 may be used as the physical input output elements of the graphical user interface (GUI), for multimedia (e.g., audio and/or video) communications. Of course other user interface elements may be used, such as a stylus and touch sensitive display screen, as in a PDA, tablet computer, or smart phone. In addition to normal telephone and data communication related input/output (including message input and message display functions), the user interface elements also may be used for display of menus and other information to the user and user input of selections, for example, including any needed to provide order confirmation information or related acknowledgments requested by the order server 33 (or CRM 25).

The mobile device 103e also includes a transceiver 622. For example, the transceiver 622 may comprise a near field communication (NFC) chipset, which includes an NFC transceiver. In this example, the NFC chipset 622 provides two-way wireless communication of information in accordance with NFC technology and protocols. The NFC chipset 622 also sends and receives a variety of signaling messages for establishing NFC links with other NFC-enabled devices. The NFC chipset 622 is connected to a NFC antenna 624, which is used for transmitting and receiving NFC communications to/from other NFC compatible devices, such as the NFC terminals discussed herein.

In the example, a microprocessor 112 serves as a programmable controller or processor, in that it controls all operations of the mobile device 103e in accord with programming that it executes, for all normal operations, and for operations involved in selecting product/service from a menu and sending order information to an order server 33 under consideration here. In the example, the mobile device 103e includes flash type program memory 114, for storage of various “software” or “firmware” program routines and mobile configuration settings, such as mobile telephone number (MTN or MDN), etc. The mobile device 103e may also include a non-volatile random access memory (RAM) 116 for a working data processing memory. In a present implementation, the flash type program memory 114 stores firmware such as a boot routine, device driver software, an operating system, call processing software and vocoder control software, and any of a wide variety of other applications, such as client browser software and short message service software. The memories 114, 116 also store various data, such as telephone numbers and server addresses, downloaded data such as multimedia content, and various data input by the user. Programming stored in the flash type program memory 114, sometimes referred to as “firmware,” is loaded into and executed by the microprocessor 112. Accordingly, the mobile device 103e includes a processor, and programming stored in the flash memory 114 configures the processor so that the mobile device is capable of performing various desired functions, including making menu selections, sending order information to an order server, receiving order status updates, and the like.

As discussed above, functions relating to making one or more selections from a menu of product/service can be performed on one or more computers connected for data communication via the components of a packet data network, including mobile devices, in accordance with the methodology of FIGS. 3a to 3c. An exemplary mobile device 103e has been discussed above with respect to FIG. 4. Although special purpose devices may be used as the server(s), for example for any of the servers 25 to 33 in FIG. 1, such devices also may be implemented using one or more hardware platforms intended to represent a general class of data processing device commonly used to run “server” programming so as to implement the functions discussed above, albeit with an appropriate network connection for data communication.

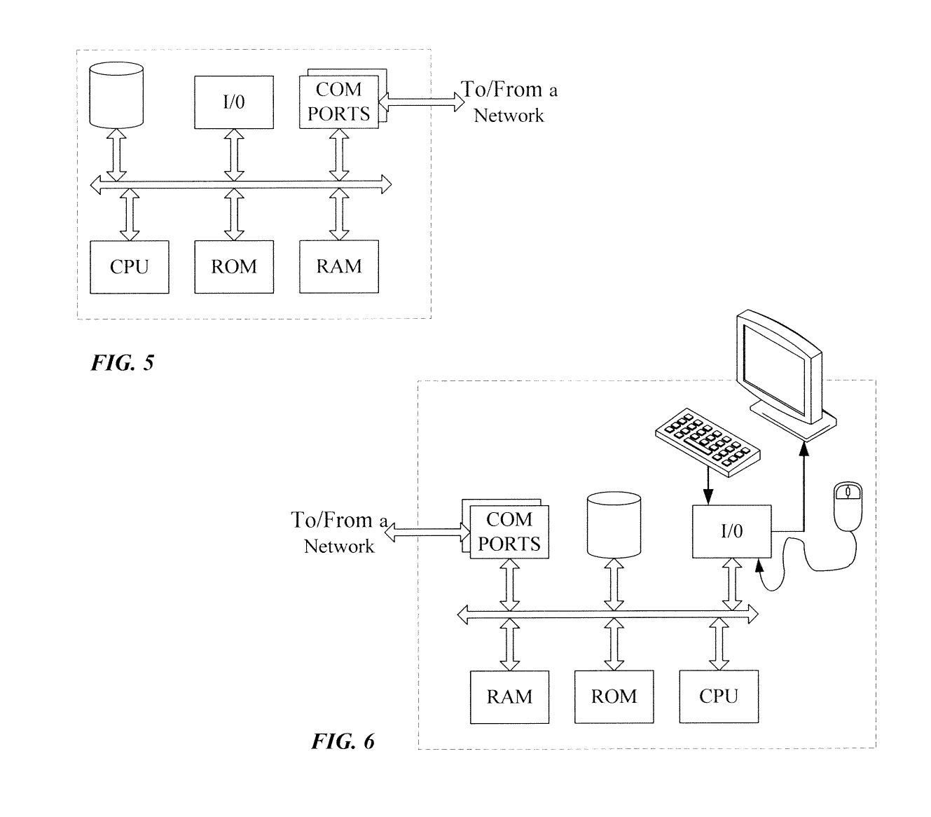

FIGS. 5 and 6 provide functional block diagram illustrations of general purpose computer hardware platforms, as might be used as an order server 33, CRM 25, or other computers discussed in the examples above. FIG. 5 illustrates a network or host computer platform, as may typically be used to implement a server. FIG. 6 depicts a computer with user interface elements, as may be used to implement a personal computer or other type of work station or terminal device, although the computer of FIG. 6 may also act as a server if appropriately programmed. It is believed that programming and general operation of such computer equipment, and as a result the drawings, should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

Hence, aspects of the methods of making product/service selection(s) (e.g., from a menu), sending order information to an order server 33, and sending status order status updates to mobile device, as outlined above, may be embodied in programming for a server and programming for a mobile device. Program aspects of the technology may be thought of as “products” or “articles of manufacture” typically in the form of executable code and/or associated data that is carried on or embodied in a type of machine readable medium.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. This the following claims are hereby incorporated into the Detailed Description, with each claim standing on its own as a separately claimed subject matter.

### APPENDIX

### Acronym List

The description above has used a large number of acronyms to refer to various services, messages and system components. Although generally known, use of several of these acronyms is not strictly standardized. For the convenience of the reader, the following list correlates terms to acronyms, as used by way of example in the detailed description above.

3GPP2: 3'rd Generation Partnership Project 2

BREW: Binary Runtime Environment for Mobile

BS: Base Station

BTS: Base Transceiver System

CDMA: Code Division Multiple Access

CPU: Central Processing Unit

CRM: Customer Relations Management

EVDO: Evolution Data Optimized

GPS: Global Positioning System

GSM: Global System for Mobile

GUI: Graphical User Interface

IMS: Internet Protocol Multimedia Subsystem

ID: Identification

LTE: Long Term Evaluation

MDN: Mobile Directory Number

MTN: Mobile Telephone Number

NFC: Near Field Communication

PDA: Personal Digital Assistant

PDN: Packet Data Network

POTS: Plain Old Telephone Service

PSTN: Public Switched Telephone Network

RAM: Random Access Memory

RAN: Radio Access Network

RF: Radio Frequency

SMS: Short Message Service

TDMA: Time Division Multiple Access

WAN: Wide Area Network

XCVR: Transceiver

1. A mobile device, comprising:
a wireless transceiver configured for mobile data communication via a mobile wireless communication network;
a near field communication (NFC) transceiver;
at least one user interface element; and
a controller coupled to the transceivers and the at least one user interface element, wherein the controller is configured to control operations of the mobile device to implement functions, including functions to:
offer a menu of an establishment;
receive, via the at least one user interface element, a selection of one or more items from the menu;
in response to being brought within range of an NFC terminal at a premises of the establishment, transmit an order for the one or more selected items to a server of the establishment via the NFC transceiver of the mobile device;
receive via the wireless transceiver of the mobile device a message related to the transmitted order from the server of the establishment; and
based on information from the received message, present via the at least one user interface element an indication of status of fulfillment of the order for the selected one or more items by the establishment.

2. The mobile device of claim 1, wherein the menu of the establishment includes at least one of:
(i) a single button selection option to order the same one or more items from a prior order; or
(ii) a special tailored for the customer based on customer information from a customer information database.

3. The mobile device of claim 1, wherein in response to being brought within range of an NFC terminal at the premises of the establishment, the controller is further configured to implement the functions to:
(i) indicate to the server that the customer is a correct recipient of the one or more selected items, and
(ii) provide payment information to the establishment.

4. The mobile device of claim 1, wherein the transmission of the order indicates arrival of the customer at the premises of the establishment.

5. The mobile device of claim 1, the functions further comprising:
in response to the transmission of the order, presenting at the at least one user interface element specials or promotions information based on customer information.

6. The mobile device of claim 5, wherein the customer information includes at least one of: (i) order information from one or more prior orders or (ii) profile information of the customer.

7. The mobile device of claim 1, wherein the controller is further configured to control operations of the mobile device to implement a function to transmit an initial order to the server of the establishment over at least one of (i) an internet, or (ii) a mobile communication network, wherein:
the initial order is placed by the wireless transceiver,
the initial order is transmitted to the server before the order, and
the order is a confirmation of the initial order.

8. The mobile device of claim 7, further comprising a global positioning system (GPS) receiver, wherein:
the controller is further configured to control operations of the mobile device to implement a function to provide at least one of a distance or GPS information to the server of the establishment via a message using the wireless transceiver; and
fulfillment of the initial order is triggered when the mobile device is a predetermined distance from the premises of the establishment.

9. The mobile device of claim 8, wherein the controller is further configured to implement the function to periodically provide the at least one of distance or GPS information to the server of the establishment, until the one or more items are received by the customer.

10. The mobile device of claim 8, wherein the controller is further configured to control operations of the mobile device to implement a function to trigger fulfillment of the initial-order at a predetermined distance based on at least one of area or time.

11. The mobile device of claim 7, wherein the controller is further configured to control operations of the mobile device to implement a function to provide at least one of a distance or global positioning system (GPS) information to the server of the establishment via a message over the mobile communication network, wherein:
fulfillment of the initial order is triggered by the mobile device after a predetermined time from when the initial order is transmitted, and
the predetermined time is based on the distance or GPS information.

12.-22. (canceled)

23. A method comprising steps of:
offering a menu of an establishment via at least one user interface element of a mobile device;
receiving, via the at least one user interface element, a selection of one or more items from the menu;
in response to being brought within range of a near field communication (NFC) terminal at a premises of the establishment, transmitting an order for the one or more selected items to a server of the establishment via an NFC transceiver of the mobile device;
receiving via a wireless transceiver of the mobile device, configured for mobile data communication via a mobile wireless communication network, a message from the server of the establishment; and
based on information from the received message, presenting via a user interface element an indication of status of fulfillment of the order for the selected one or more items by the establishment.

24. The method of claim 23, further comprising in response to being brought within range of an NFC terminal at the premises of the establishment:
(i) indicating to the server that the customer is a correct recipient of the one or more selected items, and
(ii) providing payment information to the establishment.

25. The method of claim 23, wherein transmitting the order indicates arrival of the customer at the premises of the establishment.

26. The method of claim 23, further comprising:
in response to the transmission of the order, receiving at the mobile device specials or promotions information based on customer information.

27. The method of claim 26, further comprising transmitting an initial order to the server of the establishment over at least one of (i) an internet, or (ii) a mobile communication network, wherein:
the initial order is placed by the wireless transceiver,
the initial order is transmitted to the server before the order, and
the order is a confirmation of the initial order.

28. The method of claim 27, further comprising:
providing at least one of a distance or GPS information to the server of the establishment via a message using the wireless transceiver; and
triggering fulfillment of the initial order when the mobile device is a predetermined distance from the premises of the establishment.

29. The method of claim 28, further comprising periodically providing the at least one of distance or GPS information to the server of the establishment, until the one or more items are received by the customer.

30. The method of claim 28, further comprising triggering fulfillment of the initial order at a predetermined distance based on at least one of area or time.

31. The method of claim 27, further comprising providing at least one of a distance or global positioning system (GPS) information to the server of the establishment via a message over the mobile communication network, wherein:
fulfillment of the initial order is triggered by the mobile device after a predetermined time from when the initial order is transmitted, and
the predetermined time is based on the at least one of distance or GPS information.

32. The mobile device of claim 1, wherein the controller is further configured to implement the function to:
send an acknowledgment to the server upon receiving the message from the server via the NFC transceiver.
